(19) United States
(12) Patent Application Publication
(10) Pub. No.: US 2023/0061854 A1
(43) Pub. Date: Mar. 2, 2023

(54) ARM EXTENSIONS FOR QUADRUPEDAL MOVEMENT AND METHODS OF USE

(71) Applicant: QuadruFit LLC, Wilmington, DE (US)

(72) Inventor: Terry Notary, Woodland Hills, CA (US)

(21) Appl. No.: 17/900,569

(22) Filed: Aug. 31, 2022

Related U.S. Application Data
(60) Provisional application No. 63/239,382, filed on Aug. 31, 2021.

(51) Int. Cl. A63B 31/11

(52) U.S. Cl. CPC A63B 31/11; A63B 2031/112

(57) ABSTRACT

An arm extension apparatus comprising a propulsion blade comprising a top half and a bottom half, wherein the top half is generally straight and wherein the bottom half comprises a curve, and wherein the bottom half comprises a proximal end and a distal end, and wherein the distal end comprises a foot, and wherein the foot comprises two split toes.

### PRIORITY

This application claims priority to U.S. provisional Pat. App. 63/239,382, filed Aug. 31, 2021, and entitled “ARM EXTENSIONS FOR QUADRUPEDAL MOVEMENT AND METHODS OF USE,” the disclosure of which is hereby incorporated by reference in its entirety.

### TECHNICAL FIELD

Embodiments of the technology relate, in general, to arm extensions for quadrupedal movement, and in particular, to arm extensions which comfortably fasten to the forearms of a human user, allowing the user the ability to extend the reach length of his or her arm in multi-adjustable lengths.

### BACKGROUND

A human in a bi-pedal (two-footed) upright standing position can benefit in many ways from adopting a quadrupedal (four-footed) position like that of our ancestors. Along with strengthening the body physically, cross-lateral quadrupedal movement can help balance the left and right hemispheres of the brain by stimulating the corpus callosum and building communication bridges between them. Quadrupedal movement requires full integration of all four limbs working in synchronous balance. If a person simply puts two hand and two feet on the ground, it does not result in an anatomically-correct quadrupedal position. So, there is a need for an apparatus which allows a human to adopt a posture which enables them to replicate the movement of our quadrupedal ancestors.

Crutches take the weight off an injury sustained to a part of a person's hip, leg, ankle, etc., for example, a broken femur or a sprained ankle. Crutches on the market today simply relieve pressure on an injury while allowing the user to continue traveling in a bi-pedal locomotion. Crutches act as two legs with the non-injured leg acting as the third balancing leg.

There is a need for equipment with a completely different set of proportions and features that allow a user to assume an entirely different position. There is a desire to enable the bi-pedal anatomy of a human to assume an anatomically-correct quadrupedal position that allows all four limbs of the body to work synchronously in a cross-lateral pattern.

There is a need for arm extensions which allow a user to reposition their bi-pedal human anatomy into an anatomically correct, quadrupedal position. There is a desire for arm extensions which may be used as an exercise apparatus, wherein the arm extensions allow the user to perform a series of specially designed quadrupedal movements and exercises.

There is a need to allow a human user the ability to position his or her body in a quadrupedal position and achieve a prone position that, in turn, allows him or her to access all four limbs to accomplish a variety of unique, full-body, synchronous, cross-lateral exercise patterns to replace large, heavy stationary exercise machines common in gyms today. There is a need for convenient, easily transportable, no-electricity-needed exercise equipment that allows a user to utilize her own body weight, as an ‘organic weight system’, without the need for weights, bows, or bungee systems. There is a need to lessen the potential for a user to injure himself, as is common when exercising with: heavy weights that can create pinch points, bending resistance bars or springs that can recoil or strike the user, or bungee resistance bands that can fail and seriously injure the user. There is a need for exercise equipment that allows for low-impact, full-body engagement of all of muscle groups simultaneously.

Most treadmills for professional use in the fitness area have belt sizes of around 150 cm (60 in) long and around 50 cm (20 in) wide with a speed range of about 0-20 km/hour (0-12 mph) and slope angle of 0-20 degrees. The TV monitor/screen is positioned at just below eye level—generally around 4 feet high. There is a need for a treadmill which can safely accommodate quadrupedal movement.

### SUMMARY

An arm extension apparatus comprising a propulsion blade comprising a top half and a bottom half, wherein the top half is generally straight and wherein the bottom half comprises a curve, and wherein the bottom half comprises a proximal end and a distal end, and wherein the distal end comprises a foot, and wherein the foot comprises two split toes.

### BRIEF DESCRIPTION OF THE DRAWINGS

The present disclosure will be more readily understood from a detailed description of some example embodiments taken in conjunction with the following figures:

FIG. 1 is a side perspective view of a first exemplary arm extension;

FIG. 2 is a bottom perspective view of the arm extension of FIG. 1;

FIG. 3 is a bottom view of the arm extension of FIG. 1;

FIG. 4 is a top view of the arm extension of FIG. 1;

FIG. 5 is a left side perspective view the arm extension of FIG. 1;

FIG. 6 is a right side perspective view of the arm extension of FIG. 1;

FIG. 7 is a front view of the arm extension of FIG. 1;

FIG. 8 is a left side view of the arm extension of FIG. 1;

FIG. 9 is a right side view of the arm extension of FIG. 1;

FIG. 10 is a side perspective view of a second exemplary arm extension, this one comprising a pull-up hook;

FIG. 11 illustrates fit of an arm extension;

FIG. 12 illustrates a pair of arm extensions and a related mobile phone app;

FIG. 13 illustrates use of a pair of arm extensions; and

FIG. 14 illustrates a side view of a treadmill.

### DETAILED DESCRIPTION

Various non-limiting embodiments of the present disclosure will now be described to provide an overall understanding of the principles of the structure, function, and use of the compositions, methods, and processes disclosed herein. One or more examples of these non-limiting embodiments are illustrated in the accompanying drawings. Those of ordinary skill in the art will understand that compositions and methods specifically described herein are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The inventor conceived of novel arm extensions for quadrupedal movement and methods of use that, for the purpose of illustration, are disclosed herein as applied in the context of a fitness apparatus. While the disclosed applications of the inventor's arm extensions satisfy a long-felt but unmet need in the art of fitness, it should be understood that the inventor's arm extensions are not limited to being implemented in the precise manners set forth herein, but may be implemented in other manners without undue experimentation by those of ordinary skill in the art in light of this disclosure. Accordingly, the examples set forth herein should be understood as being illustrative only, and should not be treated as limiting.

The arm extensions replicate the anatomy of the front forearms of a quadrupedal animal and allow a human user to perform a series of cross-lateral, quadrupedal movements and exercises with anatomically correct, ergonomic proportions that mimic the proper anatomy and proportions of quadrupedal animals such as apes, dogs, cats, horses (long list of quadrupedal animals). As the user exerts pressure and force upon the arm extension, the propulsion blade bends, flexes and contours with bio-mechanically correct flexion and load response that enables the user to exert a downward force or weight load that flexes the blade and thus translates into potential energy. The contoured propulsion blade design allows for an incredibly efficient, bio-mechanically correct, return on potential energy response, or propulsion. The propulsion blade's specially designed ‘S-Curve’ ensures that a user is reaching maximum potential energy during use, e.g., when she propels herself through signature movements and exercises.

Generally, the arm extensions solve several problems. 1) The arm extensions allow the user the ability to position their body in a quadrupedal position that would be otherwise impossible to accomplish without the arm extensions. 2) The arm extensions allowing the user to achieve a prone position that, in turn, allows them to access to all four limbs in a variety of unique, full-body, synchronous, cross-lateral exercise patterns. This has never been achievable using the standard bi-lateral exercise equipment that is currently on the market. 3) The arm extensions allow the user to utilize their own body weight, as an ‘organic weight system’, without the need for weights, bows, or bungee systems. 4) The arm extensions lessen the potential for the user to injure themselves because there are no: heavy weights that can create pinch points, bending resistance bars or springs that can recoil or strike the user, or bungee resistance bands that can fail and create seriously injure the user. 5) The arm extensions allow the user to bring ‘the complete gym’ with them wherever they want to work out. Rather than being stuck working out at the same gym location, the arm extensions are ‘fully transportable’ allowing the user to bring their complete arm extensions workout routine anywhere. From the office, to the trails, to the beach, the streets, and even the gym, the uniqueness of the arm extensions allows the user to get the same workout results in any location. 6) The arm extensions allow for one piece of equipment to accomplish what it takes numerous exercise machines to accomplish. The uniqueness of the arm extensions allows the user to achieve the full range of exercise positions, eliminating the need for dozens of heavy, large and cumbersome stationary machines that are on the market today. 7) The arm extensions do not require any power or electricity to use. 8) There are no moving parts to the arm extensions. This significantly reduces the chances of injury due to pinch points, pulley failure, and human error when operating a machine. 9) Unlike machine-based exercise equipment, the arm extensions allow the user to perform exercises built on a foundation of proper technique, that allow for a full range of movements and strengthening exercises that are based on ‘intrinsic’ practicality rather than ‘extrinsic’ cosmetics. In short, the arm extensions allow the user to perform a series of exercises designed around the proper ergonomics of the human body, and ‘true strengthening’ from the intrinsic core. 10) The arm extensions allow the user to engage all of the muscle groups of the body simultaneously. The quadrupedal position, specific to the arm extensions, allows for a low-impact, full-body engagement of all of the muscle groups simultaneously. This is unlike exercise equipment on the market today that targets singular, isolated muscle groups of the body, e.g., the bicep curl machine or quadriceps leg machine. 11) Unlike other exercise machines on the market, the arm extensions allow people of all ages and height ranges to reap the benefits of the arm extensions' exercise program. The arm extensions are fully adjustable and safe for all ages and heights.

The arm extensions were designed around the ergonomics and anatomy of the human body with proper proportions and customizable adjustability for the user. These details in the design allow the arm extensions to replicate an extension of the body with the proper dynamics that allow the user to perform anatomically correct movements with a full range of motion. The arm extensions fit over the forearm of the user, extending the reach/length of the user's arm in multi-adjustable lengths ranging from about 6″ to about 24″ in length. This allows the user to position himself in a quadrupedal position where all four limbs of the body are positioned in an anatomically correct quadrupedal position. The signature quadrupedal positioning of the exercises allows for a full-body, low-impact exercise routine with a unique piece of equipment that provides a high energy-input-to-return ratio, and correct alignment of the anatomy.

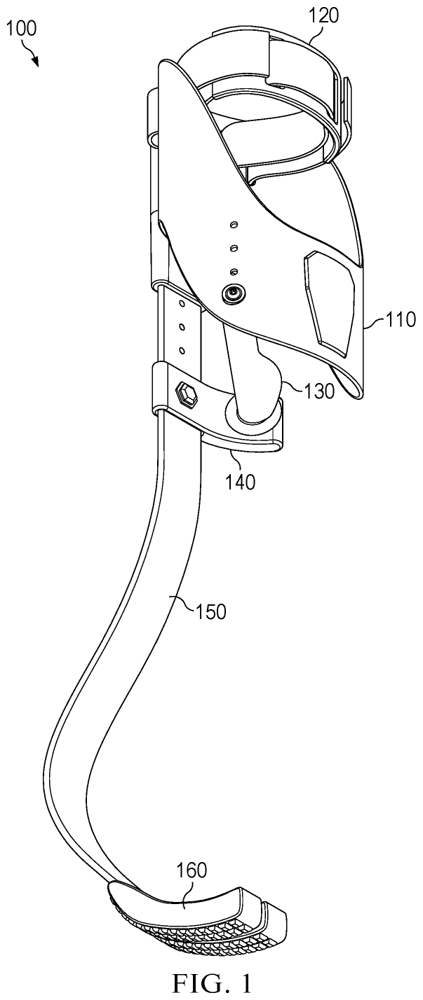

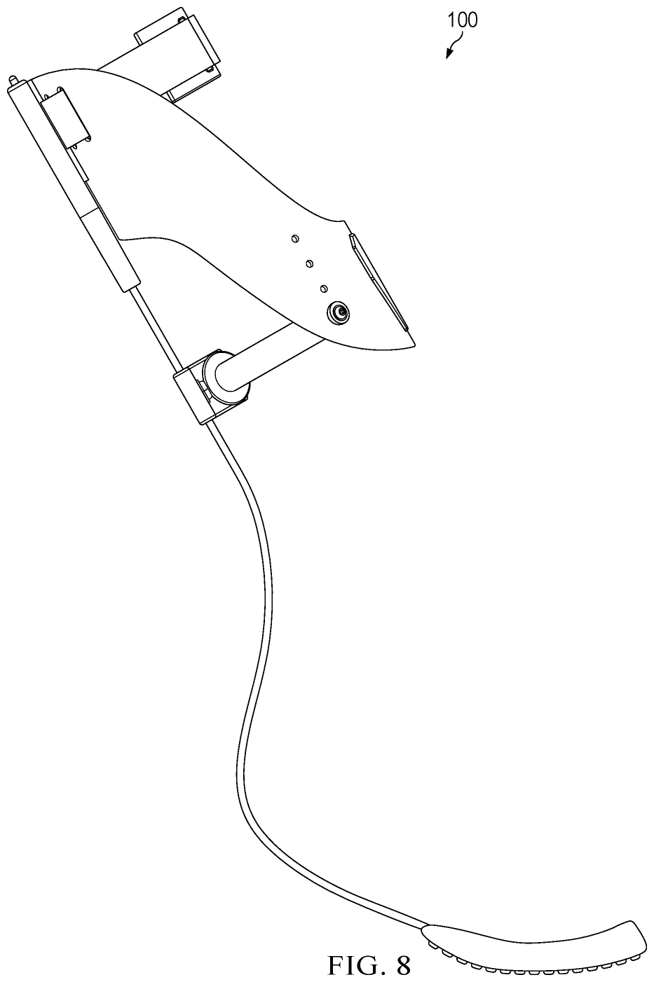

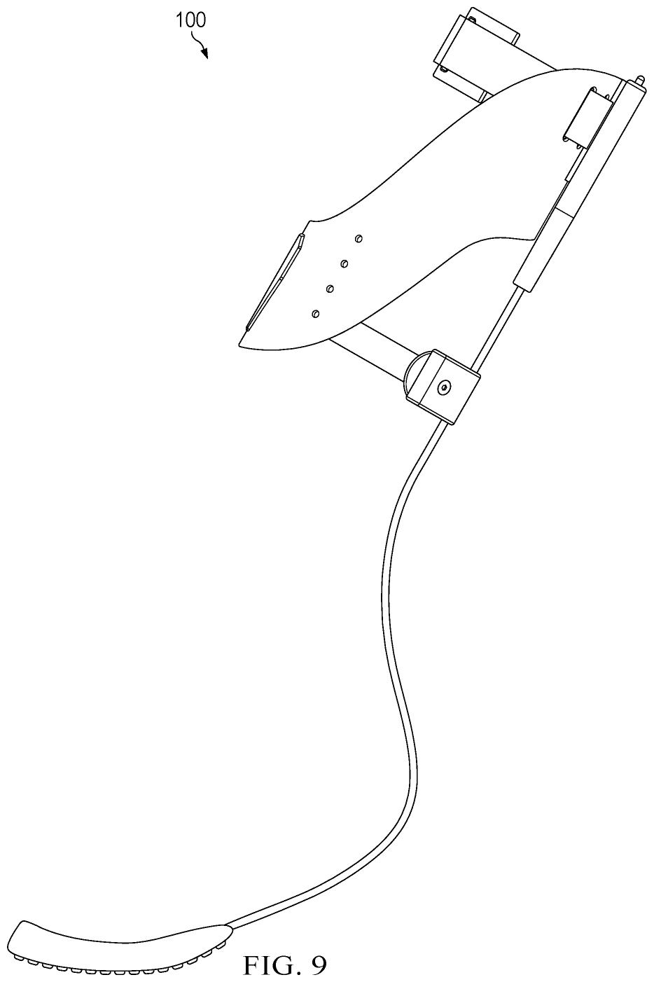

In one embodiment, as shown in FIGS. 1-9, an arm extension is constructed out of a specially-designed, variable-layered, carbon-fiber extension that is specially contoured to maximize a user's weight-load-to-energy-return ratios for optimal propulsion. The arm extension comprises: 1) a double-Velcro® strap system for fail-proof fit and adherence to the forearm, 2) an ergonomic 45-degree angled handle for anatomically correct positioning of the wrist, 3) a horizontal handle angle adjustment bracket for proper weight load distribution through the palm, wrist and forearm, 4) a wide-profile handle formed from specialized high-performance gel, for added comfort, non-slip traction and stability, 5) an additional option to customize your own handle by casting a mold of your personal grip using the proprietary ‘handle mold kit’ such that the handles are custom molded to exact dimensions of the users hands, 6) a ‘foot-shoe system’ that allows the user to swap out different shoes with specialized soles designed to ensure proper traction on diverse terrain surfaces. The arm extensions are comfortable, safe, reliable, and enable the user to assume an anatomically correct quadrupedal position and perform a long list of specially-design movement patterns and exercises. In other embodiments, some of these features may be missing or altered.

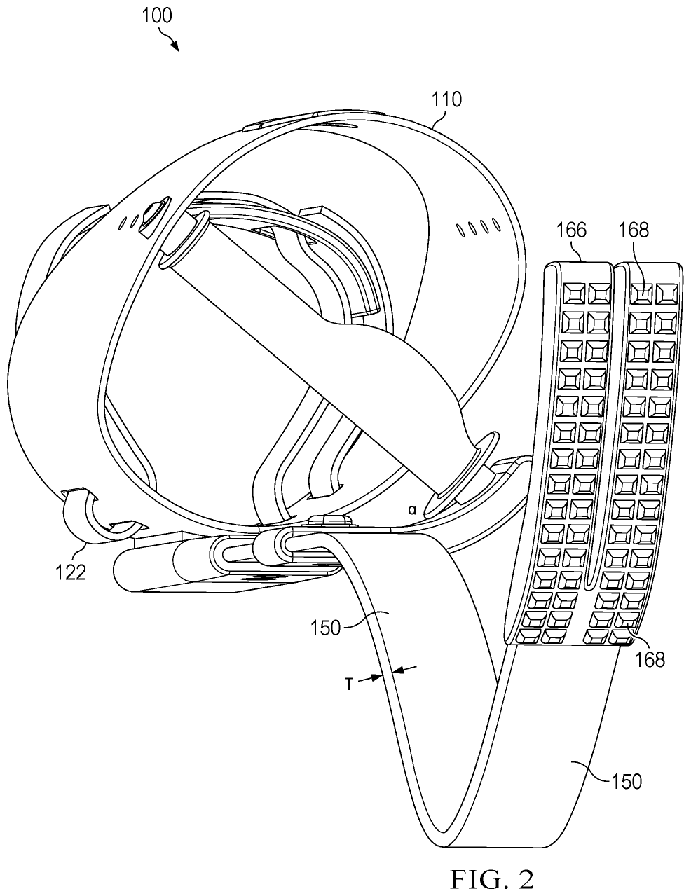

As shown in FIG. 1, the arm extension 100 comprises a grip cuff 110, an arm cuff 120, a handle 130, a grip-angle-adjustment bracket 140, a propulsion blade 150, and a foot 160. FIG. 2 shows a bottom perspective view of the arm extension 100. The foot 160 comprises a shoe 166 comprising a plurality of protrusions 168.

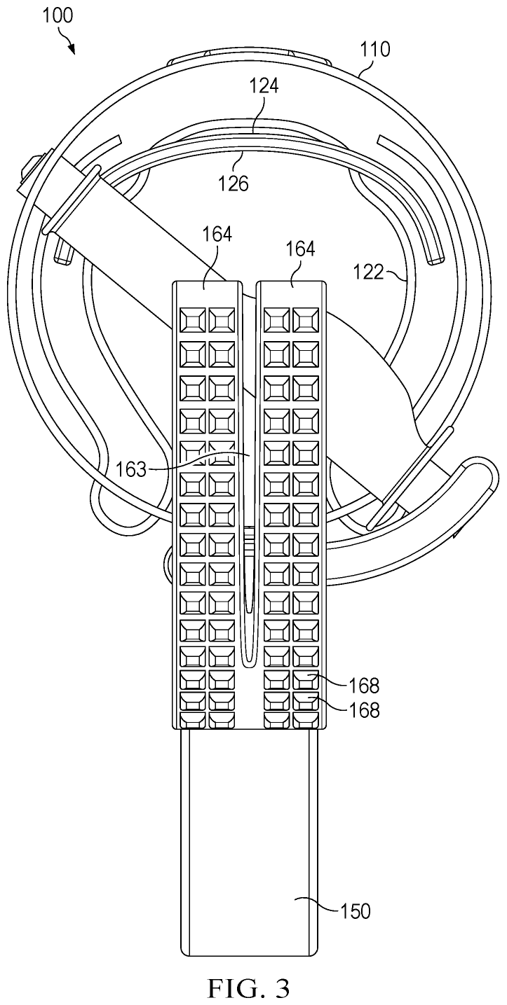

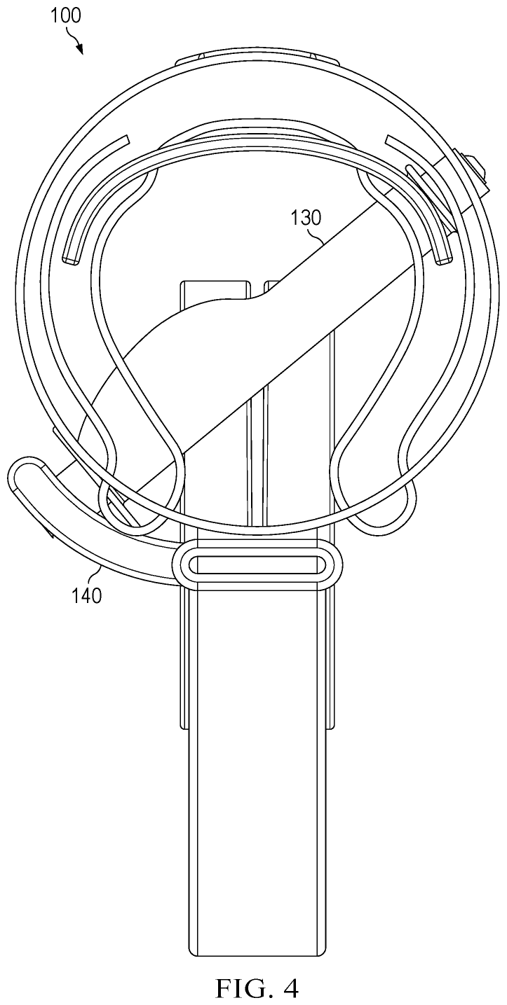

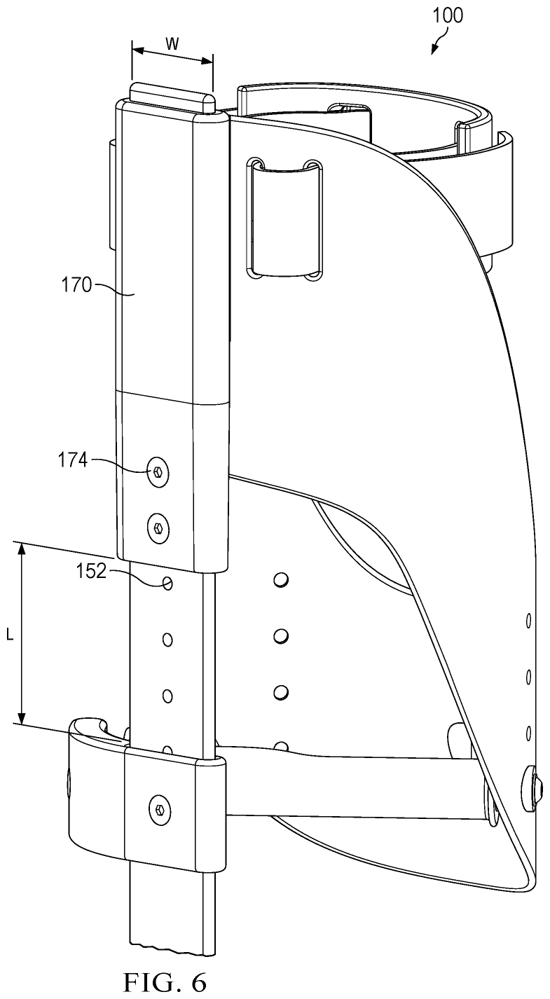

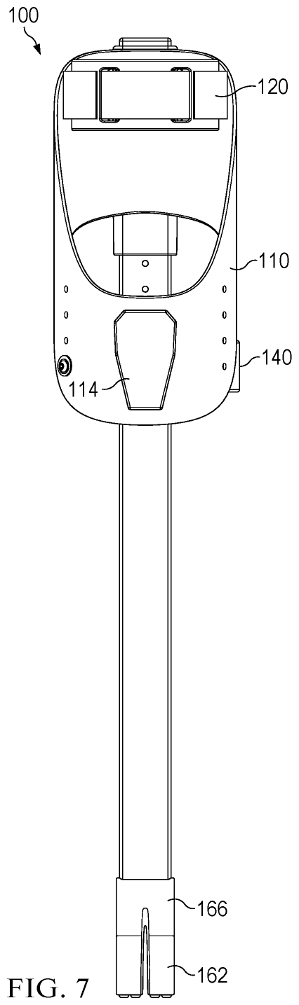

FIG. 3, a bottom view of the arm extension 100, shows the arm cuff 110 strap 122, buckle (aka stress plate) 124, and liner 126. There is a gap 163 between the two toes 164, creating a split-toe 162 foot. FIG. 4, a top view of the arm extension 100, shows the split-toe 162 foot 160 without the shoe 166. The foot 160 may be made from a different material as the propulsion blade 150. FIG. 6 shows handle adjustment points 112, which are holes in the grip cuff 110 which allow the handle 130 to be attached. FIGS. 7-9 are additional views of the arm extension.

As shown in FIG. 1, an arm extension 100 has a tubular grip cuff 110 designed for optimal strength and integrity as well as ease of use. The arm cuff comprises an ‘S’ shape carved out of a single carbon fiber tube. The design is based on nature and the rule of cylindrical integrity. The design allows for a minimal amount of material to maintain optimal strength and integrity when subjected to high stress applications like quadrupedal exercise.

The grip cuff 110 has a fully adjustable arm cuff 120 that secures the arm extension 100 to the user's arm by cinching, wrapping, and tightening around the forearm of the user and thus securing the arm extension to the user. In the embodiment of FIGS. 1-9, arm strap 122 allows a single arm cuff 120 to be adjusted to forearms ranging from young children (e.g., about 6 inches in diameter), to incredibly large forearms (e.g., over 16 inches in diameter). The arm strap 122 comprises a long strap with hook-and-loop attachments at each end (aka a “double-Velcro®” arm strap). In other embodiments, in place of (or in combination with) Vecro®, other securing methods may be used, such as a ratchet belt or straps with one or more clips.

As shown in FIGS. 3 and 4, the arm strap incorporates an arm cuff buckle 124 that acts as a stress plate. The buckle 124 sits against the user's forearm and alleviates forearm wear by reducing pressure points that can cause hotspots, soreness, and fatigue of the forearm. The arm cuff buckle 124 has a contoured/flex design that is specially shaped to contour to the anatomy of the arm and has a particular degree of flexion and mobility that allows the arm cuff buckle to mold and conform to the shape of the individual user's forearm. The flexion and mobility of the arm cuff buckle allows for an efficiency and uniformity in the points of contact along the users forearm in order to ensure optimal fit and comfort to the user. In one embodiment, the arm cuff buckle 124 comprises a removable, fully washable liner 126. The liner 126 may be made out of a material which comprises one or more of these features: comfortable, gripping, slip resistant, antimicrobial, sweat absorbing. For example, the liner 126 may be made out of a rubber such as Neoprene®.

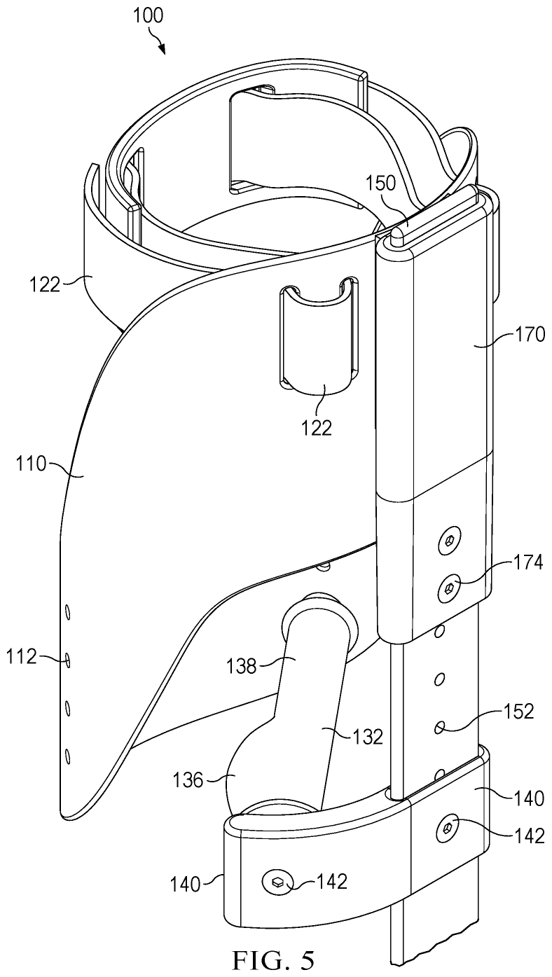

As shown in FIGS. 4 and 5, handle 130 distributes the weight of a user evenly across the palm of the hand at an adjustable wrist angle to ensure ergonomics and proper alignment of the stress load as it translates through the bones and tendon of the hand, the forearm, shoulder etc. The handle 130 has an extra-large, contoured sole 132 that allows the palm of the hand to make uniform contact with the handle. The sole's 132 large surface area eliminates fold and pinch points along the edge of the handle and decreases soreness due to hotspots and overall fatigue of the muscles in the hand. The sole 132 comprises a larger diameter portion 136 and a smaller diameter portion 138. In one embodiment, the handle comprises a blend of robust, high-performance, sweat-resistant, gel materials infused with anti-slip, contoured rubber. In one embodiment, the handle design includes ergonomic, contoured finger channels 134 that allow the hand more purchase and horizontal stability.

In some embodiments, a pair of arm extensions may come with two or more handles. In one embodiment, handles or an associated handle mold kit offers a customizable option to have personalized handles made to the exact size and shape of the user's own hand. In one embodiment, a personalization kit comes as two or more pieces of impressionable foam, such as a cylindrical handle shape, which can be squeezed to impart a personalized grip mold for the right hand and the left hand, which can in turn be shipped to a handle manufacturer so that personalized handles can be manufactured and sent to the user. In one embodiment, a handle kit enables a user to personalize two or more handles himself in a short amount of time.

As shown in FIGS. 5-6, a grip-angle-adjustment bracket (aka ‘wrist angle mount’ aka ‘handle angle bracket’) 140 having adjustment screws 142, in combination with handle adjustment points 112 on the grip cuff 110, allows the user to adjust the handle 130 both vertically along the length L of a propulsion blade 150 and horizontally along the width W of the propulsion blade with respect to the grip cuff to ensure proper alignment and angle of the wrist. This ensures proper lines of weight distribution as force travels from the foot 160 of the arm extension and translates through the hand, wrist, forearm, shoulder and torso of the user. In one embodiment, the arm extensions have an about 45-degree angle a handle mount. This mount allows the user to position their hand and arm in the most ergonomic and anatomically correct position when performing quadrupedal movements and exercises.

A height-adjustment slider bar 170 (aka ‘adjustment slider bar’) can slide vertically along the length L of the propulsion blade, allowing the user to adjust the height of the handle to match the optimal anatomical height of their quadrupedal position. It also allows the user to increase or decrease the height of the arm extensions. Increasing and or decreasing the height of the arm extensions allows the user to increase and or decrease the weight distribution ratios between the arm and legs by creating high or low angles in the body while in the quadrupedal position. In one embodiment, the same arm extension may be adjusted to children as short as about 3′8″ to a height that will fit an adult as tall as about 6′9″. In another embodiment, an array of arm extensions of different initial, unadjusted sizes (e.g., small, medium, large) may be offered to accommodate a variety of user sizes. FIG. 5 shows blade holes 152 and slider bar adjustment screws 174.

FIG. 7 shows a grip cuff 110 feature 114. The feature may comprise a logo, a reflector, a pocket, a sensor, a light, or combinations thereof.

Propulsion blades may be primarily manufactured with aluminum tubing, graphite, fiberglass bar, carbon fiber bar, or the like, or combinations thereof In one embodiment, the propulsion blades comprise carbon fiber; in another embodiment, they comprise multi-layer carbon fiber. In one embodiment, a cross-weave carbon fiber pattern allows the propulsion blade to reach optimal sideways torque stress loads with a fail proof integrity—even under the most severe conditions. This carbon fiber cross-weave pattern enables the user to replicate the anatomical proportions of a quadrupedal animal while performing movements such as quadrupedal walking, running, cantering, galloping, and sprinting. In one embodiment, the propulsion blade has an internal composition design that incorporates two cross-weave layers of Kevlar® that lay sandwiched between sixteen layers of cross-weave, 10 Mil carbon fiber. This double layer of Kevlar® ensures that the user can place stress loads ten times their body weight and guarantee that the propulsion blade will maintain its strength and integrity, without fail, even under the most severe stress load conditions.

In one embodiment, the propulsion blade has a variable thickness T to allow for high performance flection at critical points of energy transfer as well as stiffness and integrity at critical stress points along the arm extensions. This variable thickness of the carbon fiber along the arm extensions allows optimal stability, strength, integrity, contouring and traction when performing high intensity movements and exercises in a quadrupedal position. The variable thickness of the carbon fiber also allows optimal performance of potential energy load, energy return and traction response on terrain surfaces that include asphalt, concrete, dirt, mud, sand, gravel, snow and ice.

In some embodiments, a split-toe 162 (aka ‘Forked-Toe’) design of the foot 160 of the arm extension 100 increases the footprint/surface area of the foot 160 of the propulsion blade 150, allowing for increased stabilization and traction of the user. The split-toe 162 minimizes torque stress loads while the user is performing actions such as carving through a turn by exerting severe twisting, downward pressure, and sideways torque along the arm extension 100. Like a human foot and ankle responds under the weight of a runner while leaning into a turn, the split-toe 162 on the arm extension 100 spreads, twists, flexes and contours to the terrain and allows the foot 160 of the arm extension 100 to distribute the stress load evenly and maintain firm contact to flat and uneven contours of the ground equally. This splaying of the toes 164 on the foot 160 of the arm extension 100 coupled with the variable thickness T of the carbon fiber propulsion blade 150 allows for sideways flexion, even distribution of sideways torque load, and significant reduction of the twisting strain along the length of the arm extensions. This dispersion allows for optimal flexion and energy return even under severe stress conditions like pressing down and twisting simultaneously.

In the embodiment of FIGS. 1-9, the foot 160 is in the form of a two-toed split-toe 162 design. In other embodiments, a foot may comprise one, two, three, four, or five toes. For instance, a foot may mimic a human, ape, or monkey foot and have a five-toed split-toe design.

The arm extension 100 may be paired with a shoe 166 that fits over the foot 160. The shoe 166 may accommodate a regular foot or a split-toe foot.

In one embodiment, the arm extensions 100 have a selection of various shoes that are each specially designed for use on a different terrain. The ‘Sprinter Shoe’ is the lightest, lowest profile design. It has a very light tread built on thin skin. The ‘Racing Shoe’ is a shoe with a thick, flat, sticky sole designed for use on asphalt and concrete. The ‘Off-Road Shoe’ has a wide, deep tread that allows for grip and traction on uneven terrain including rock, mixed trails, and gravel. The ‘All-Terrain Shoe’ is a hybrid cross between the Racing and Off-Road shoe for those who want to use the same soles for training on both road and trail. The ‘Gym Shoe’ is a lightly treaded sole that does not leave scuffs or marks on concrete, wood, or marley dance floors. The ‘Mountaineer Shoe’ is a robust sole with front toe guards to protect the user from large rocks and obstacles that could damage the lighter, lower profile designs. This shoe provides bulletproof assurance that the user can get through the roughest of terrain without the shoe failing them on their solo trek through the Andes. The ‘Snow Cat Shoe’ has a larger, wider footprint that extends out beyond the skeletal structure of the foot of the arm extension. The Snow Cat Shoe acts as a pad that stretches wide to prevent the user from sinking into snow while simultaneously providing grip and non-slip purchase. “Purchase” is defined herein as “a hold or position on something for applying power advantageously, or the advantage gained by such application” (e.g., “the horse's hooves fought for purchase on the slippery pavement”—Oxford Dictionaries).

While one arm extension is described above, in typical use situations, a user will have two arm extensions—one for her right arm and one for her left arm. Accordingly, a kit with a pair of arm extensions is generally how the extensions are used.

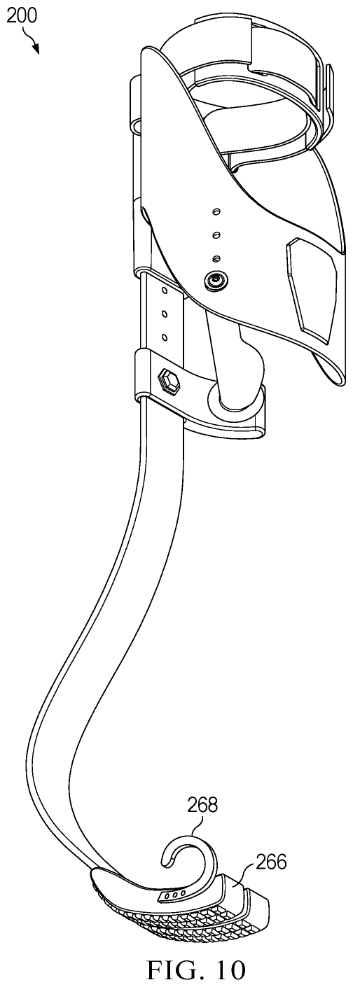

In some embodiments—such as the second exemplary arm extension embodiment 200 in FIG. 10—the arm extension 200 has a ‘Double-Hook’ design that allows the user, using a hook 268 connected to the arm extension, to hook the arm extensions to a pull-up bar, elastic band, pulley system, or use the hook to anchor their feet when performing any number of already known or proprietary exercises. The hook is generally located at the top of the foot or shoe 266 to allow the user to execute pulling exercises, but it can also be located on a side of the foot or shoe 266. The placement of the hook follows an anatomically correct line of downward force allowing for proper lines of exertion and force for the user when performing exercises that require hanging or pulling.

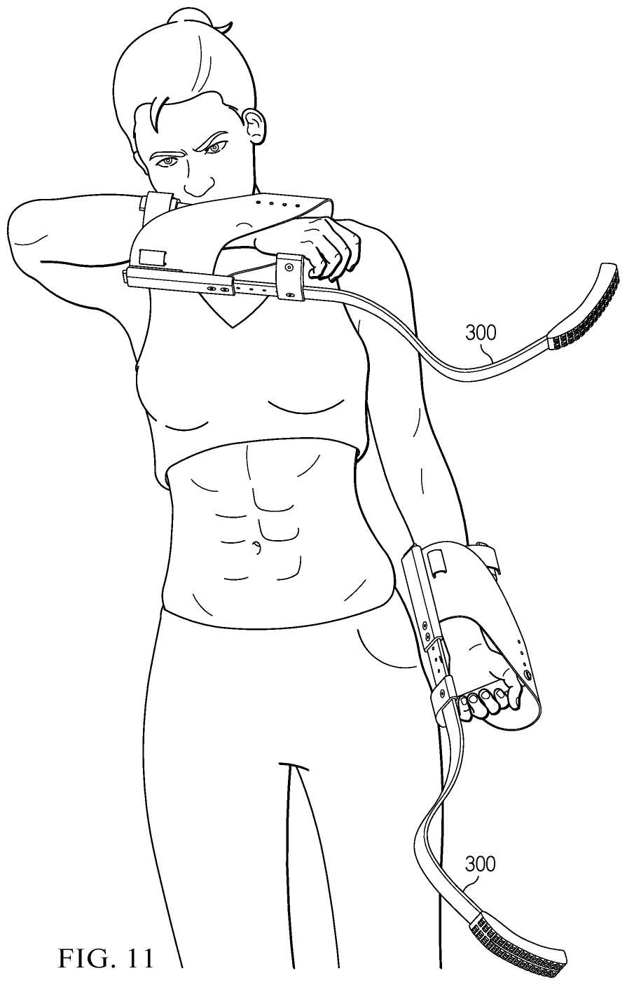

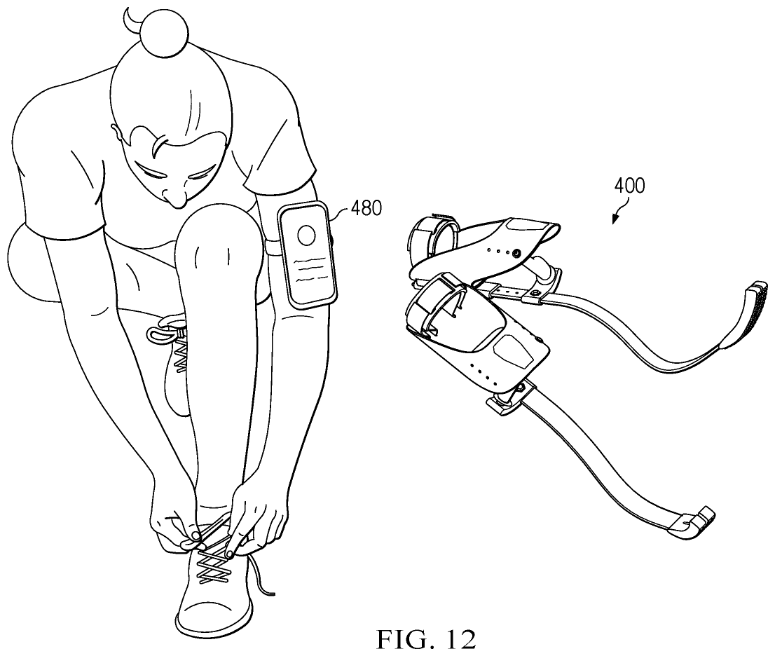

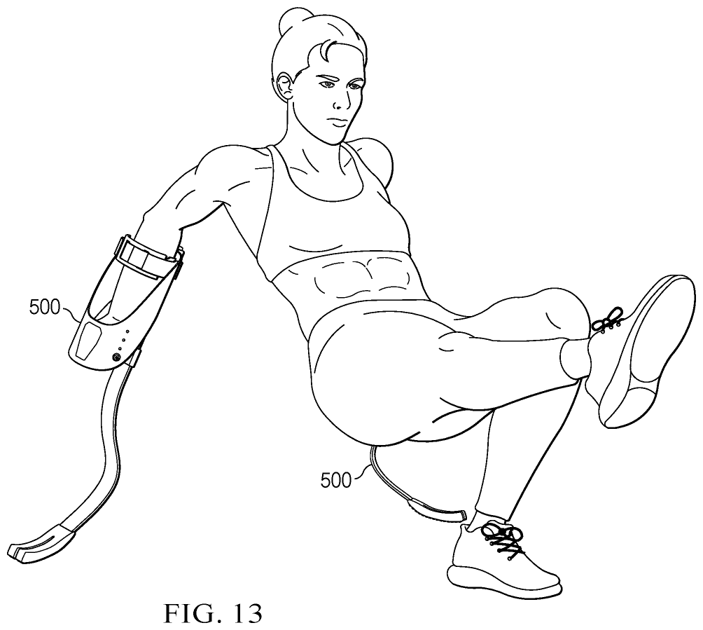

While the arm extensions may be utilized in various ways, one method of use of the arm extensions is as part of an exercise program. FIG. 11 illustrates arm extensions 300. An exercise program may comprise a unique series of quadrupedal exercises (aka movement patterns) that are performed using the arm extensions. FIG. 12 illustrates a pair of arm extensions 400 and a related electronic device 480, here, a mobile phone and training app. The mobile phone app 480 may guide users through proper movement patterns while wearing the arm extensions 400. The user is able to replicate the proper anatomical proportions of a quadrupedal animal giving the user the ability to move on all fours while performing a series of specially designed movements and exercises. Arm extensions may be used to accomplish quadrupedal group classes in a controlled gym setting. For example, FIG. 13 illustrates use of a pair of arm extensions 500 during a mat class. The arm extensions enable the user to move in cross-lateral movement patterns.

The arm extensions allow the user to position their bi-pedal human anatomy in a quadrupedal position that allows the user to access and target simultaneous muscle groups in unique ways. The exercise program allows the user to target all of the muscle groups of their body simultaneously by utilizing the user's own body weight as a natural gravitational weight system. The exercise program educates the user to execute synchronized, full-body, circular, cross-lateral exercises and movement patterns. This unique set of exercises may help balance the left and right hemispheres of the brain by stimulating the corpus callosum, the pathway of neural connections that allow the left and right sides of the brain to communicate with one another. The quadrupedal movement patterns performed with the arm extensions require full integration of all four limbs working in synchronous balance. In order to coordinate these intricate movement patterns, this exercise program's mind/body integration encourages both the left and right sides of the brain to push the envelope and exercise their communication skills in ways that have never before been accessible. These unique patterns of movement are only able to be accessed by the user getting back to the root of our quadrupedal ancestry by wearing the arm extensions. The exercise program's movement patterns replicate the movement of our quadrupedal ancestors. It turns out that going back to the roots of our original movement pattern targets our brain's main neural pathways of communication, the corpus callosum, which connects (and allows communication between) the right and left hemispheres of the brain. As the corpus callosum is forced to reawaken to our original quadrupedal coordination pattern, its dormant neural connections are stimulated back to a healthy, functioning state. This exercise program increases the strength as well as the number of neural synaptic connections and in turn strengthens the brain's ability to coordinate complex movement patters, thought processing, problem solving, and leaves the user with overall sensations of calm, balance, and wellbeing. This neural strengthening of the synaptic connections of the left and right hemispheres develops a brain that is more balanced in its ability to combine analytical data (the left side of the brain) with creative problem solving (the right side of the brain) and thus develops a brain that is faster at computing and performance. In short, it makes the brain more efficient, or even, smarter.

Another method of use of the arm extensions is with a treadmill specifically designed to work with the arm extensions. In some embodiments, the treadmill belt is greater than 150 cm (60 in.) long, or greater than about 70 in. long, or greater than about 80 in. long, or greater than about 85 in. long. In some embodiments, the treadmill belt is greater than 50 cm (20 in) wide, or greater than about 20 in. wide, or greater than about 35 in. wide, or greater than about 40 in. wide. In some embodiments, the treadmill has a speed range of about 0-20 km/hour (0-12 mph) and slope angle of 0-20 degrees. The TV monitor/screen is positioned at less than 4 feet high, or less than about 3 feet high, or less than about 2 feet high.

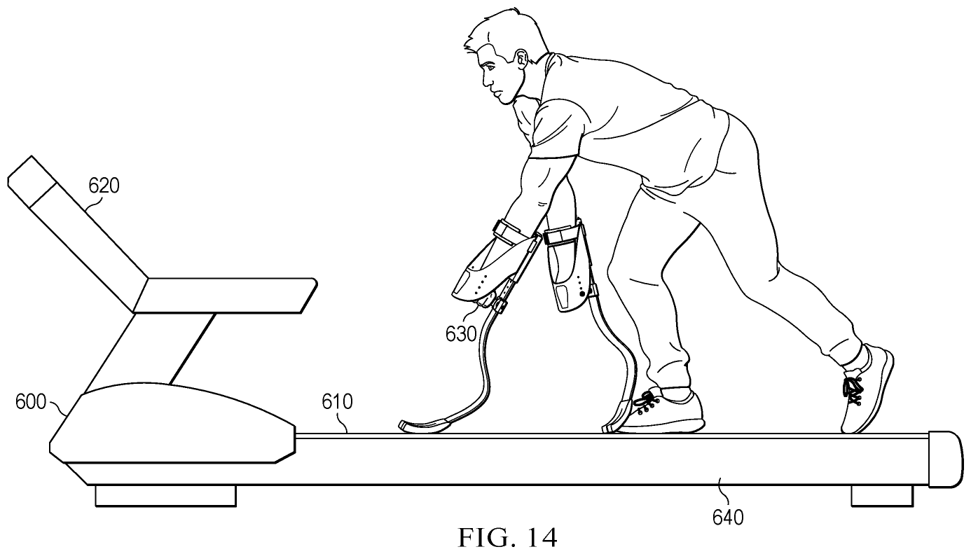

In one embodiment, shown in FIG. 14, a treadmill 600 is unique in that it has a longer and wider belt 610 than an average treadmill in order to accommodate a user's quadrupedal position while walking, trotting, and galloping. For instance, the belt 610 may be 86.4″ long x 36″ wide, or at least about 36″ wide, or at least about 86″ long. In this embodiment, the treadmill 600 has an adjustable screen (or television, monitor, projector screen, or the like) 620 that allows a user to view the screen while performing exercises in a quadrupedal position while wearing arm extensions. The screen 620 is positioned at just below eye level: in this embodiment, about 2 feet high. Preferably, the screen 620 is angled up towards the ceiling or sky to ensure the user can see the screen while exercising in the low quadrupedal position. In one embodiment, the treadmill comprises a trigger control mechanism 630 that allows the user to increase and decrease the speed and angles of the treadmill 600. For example, a Bluetooth trigger remote fits into the hand of the user and allows them to control the speed and height/angle adjustment of the treadmill while wearing the arm extensions. In one embodiment, an automatic safety, pressure-sensitive weight monitor 640 will shut off the treadmill as soon as a user's weight is no longer registered on the treadmill.

While the arm extensions are mainly described herein in a fitness context, the arm extensions may also be useful to other user populations or for other purposes. For instance, actors playing quadrupedal characters, schools, people with post-traumatic stress disorder, spinal injuries, scoliosis, amputees, autism, attention-deficit/hyperactivity disorder, cerebral cortex malfunction, stroke, old, young, and everyone in between, left/right brain coherence for people with brain imbalance, post brain surgery, and more may benefit from arm extension programs.

While specific embodiments were illustrated and described herein, variations and modifications may be made by those skilled in the art without departing from the scope of this disclosure. The present disclosure is for purposes of illustration and not of limitation; it may take many forms other than those explicitly disclosed herein. As such, the claims below shall be read to include all obvious variations and modifications that may be within the spirit of this disclosure.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto. As such, the claims below shall be read to include all obvious variations and modifications that may be within the spirit of this invention.

What is claimed is:

1. An arm extension comprising:
a. a propulsion blade comprising a top half and a bottom half, wherein the top half is generally straight and wherein the bottom half comprises a curve, and wherein the bottom half comprises a proximal end and a distal end, and wherein the distal end comprises a foot;
b. a grip cuff and an arm cuff adjustably attached to the top half of the propulsion blade; and
c. a handle comprising a first end and a second end, wherein the first end is connected to a grip-angle adjustment bracket and the second end is connected to the grip cuff

2. The arm extension of claim 1, wherein the propulsion blade comprises carbon-fiber.

3. The arm extension of claim 1, wherein the propulsion blade comprises a ribbon shape.

4. The arm extension of claim 1, wherein the arm cuff comprises a strap.

5. The arm extension of claim 1, wherein the arm cuff comprises a buckle.

6. The arm extension of claim 1, wherein the handle is generally perpendicular to and at a 45-degree angle with the propulsion blade.

7. The arm extension of claim 1, wherein the handle has a sole comprising a material which provides comfort, non-slip traction, and stability.

8. The arm extension of claim 1, wherein a shoe covers the foot.

9. The arm extension of claim 1, wherein the shoe comprises protrusions on at least its bottom surface.

10. The arm extension of claim 1, wherein the foot is a split-toe design.

11. The arm extension of claim 1, further comprising a height-adjustment slider bar.

12. The arm extension of claim 1, wherein the grip cuff comprises a feature selected from the group consisting of a logo, a reflector, a pocket, a sensor, a light, or combinations thereof

13. The arm extension of claim 1, wherein the handle comprises a sole having a larger diameter portion a smaller diameter portion.

14. The arm extension of claim 1, wherein the handle is personalized and contours to a user's hand grip.

15. An arm extension apparatus comprising:
a propulsion blade comprising a top half and a bottom half, wherein the top half is generally straight and wherein the bottom half comprises a curve, and wherein the bottom half comprises a proximal end and a distal end, and wherein the distal end comprises a foot, and wherein the foot comprises two split toes.
